(19) United States
(12) Patent Application Publication
(10) Pub. No.: US 2008/0082671 A1
(43) Pub. Date: Apr. 3, 2008

(54) COMMUNICATION LINK GENERATION IN A CLOUD

(75) Inventors: Henricus Johannes Maria Meijer, Mercer Island, WA (US); Raymond E. Ozzie, Seattle, WA (US); Gary W. Flake, Bellevue, WA (US); Thomas F. Bergstraesser, Kirkland, WA (US); Arnold N. Blinn, Hunts Point, WA (US); William J. Bolosky, Issaquah, WA (US); Christopher W. Brumme, Mercer Island, WA (US); Dane A. Glasgow, Medina, WA (US); Daniel S. Glasser, Mercer Island, WA (US); Alexander G. Gounares, Kirkland, WA (US); Matthew B. MacLaurin, Woodinville, WA (US); Michael Maggs, Seattle, WA (US); Debi P. Mishra, Bellevue, WA (US); Kartik N. Raghavan, Seattle, WA (US); Ira L. Snyder, Bellevue, WA (US); Chandramohan A. Thekkath, Palo Alto, CA (US); David R. Treadwell, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/613,676

(22) Filed: Dec. 20, 2006

Related U.S. Application Data
(63) Continuation-in-part of application No. 11/536,497, filed on Sep. 28, 2006.

(51) Int. Cl. G06F 15/16

(52) U.S. Cl. 709/228; 709/227; 709/229

(57) ABSTRACT

A system and method that facilitates and effectuates communications between disparate clients that reside in a network topology (e.g., cloud). The system and method provides a component that receives one or more prospective end points, a set of desired communication criteria/characteristics, and desired content extant on one of the clients that reside on network topology. Additionally, the system and method provides a component that establishes communications pathways to one or more prospective end points or to subsequently identified end points to facilitate transfer of desired content from the end point to a requesting client.

### CROSS REFERENCE

This application is a continuation-in-part of copending U.S. patent application Ser. No. 11/536,497, filed Sep. 28, 2006, entitled “RESILIENT COMMUNICATIONS BETWEEN CLIENTS COMPRISING A CLOUD”, the disclosure of which is hereby incorporated by reference as if fully set forth herein.

### BACKGROUND

To date, applications programmers and applications programs that they have written have had to be cognizant of a plethora of factors in order to provide or to ensure seamless intercommunications between disparate applications situated on a multiplicity of network topologies and technologies that pervade our current reality. Factors that have had to be contended with include, for example, the type of firewall behind which an application is executing, the type of service that the application is connecting to, the bandwidth necessary to facilitate effectual communications between the application program and one or more disparate remote applications programs, the type of device, or devices, upon which the application program is, or prospectively will be, executing, and whether the applications program is directly communicating with a service or whether the application is communicating via a proxy service.

Until recently applications programs have typically been extremely intolerant of intermittent connectivity and generally such intermittent connectivity had not been of overriding concern given that most devices comprising the network topology had to a greater extent been connected to the network topology either via high-speed wired connections or alternatively via low speed dial up connections. However, as the numbers of possible connectivity scenarios and modalities have ballooned, the complexity associated with this exponential explosion has outstripped capabilities of applications programmers to cater to each and every possible connectivity scenario that can be encountered when establishing communications between applications.

### SUMMARY

The following presents a simplified summary in order to provide a basic understanding of some aspects of the disclosed subject matter. This summary is not an extensive overview, and it is not intended to identify key/critical elements or to delineate the scope thereof Its sole purpose is to present some concepts in a simplified form as a prelude to the more detailed description that is presented later.

The subject matter as claimed relates to a communication system that facilitates communications between disparate client and data items situated on a network topology (“Cloud”), wherein a client supplies desired capabilities, connection endpoints, and content to a connection facility. The connection facility thereafter ascertains whether a communications pathway between the connection endpoint and client can be established within a range of desired capabilities. The desired capabilities generated by the client ensures that the client promulgating the endpoint and desired capabilities can maintain seamless operability between itself and the endpoint (e.g., the capabilities can pertain to bandwidth, frame size and/or error rate).

The connection facility upon receipt of the requested end point and associated capabilities can employ a connection flowchart associated with an establishment logic to establish communications with the end point. Thus, if all desired capabilities are available the connection facility can effectuate communications immediately. Additionally, the claimed subject matter can employ one or more artificial intelligence, machine learning and/or knowledge or rule based components and/or modalities, such as for example, neural networks, fuzzy logic, Bayesian belief networks, and the like, to marshal available primitive connections and previously and/or prospectively constituted connections, and thereafter concatenate these primitive and previously and/or prospectively fabricated connections to construct and/or synthesize suitable connections. Alternatively, the connection facility can establish communication with the endpoint with a set of pre-established capabilities that may not necessarily meet all of the desired capabilities, but have nevertheless been identified as being adequate to effectuate communications between the client and the endpoint in the past. Where communication is established with a set of pre-established capabilities the connection facility can continuously attempt to upgrade the connection to accomplish the desired capabilities should these subsequently became attainable. Where desired capabilities and end point are not currently available and/or accessible the connection facility can notify the client accordingly.

More particularly, the claimed subject matter provides an interface that can receive parameters that relate to desired content that a client perceives to exist on a node or multiple nodes associated a network topology. The interface provides for the client to input a set of ideal communication parameters, and one or more locations where the client believes that the content may be located. A facility associated with the interface locates and obtains the desired content via utilization of tags associated with the content. Cryptographic authentication and biometrics can be employed to facilitate secure communications. A maintenance and upgrade facility can continuously monitor the established communications link to ensure that the link does not degrade beyond a set of pre-established and previously utilized capabilities. Where a communications link is identified as starting to or has degraded, the maintenance facility can automatically switch the communications link to an end point with equivalent capabilities without disruption in the data being interchanged. Further, where a communications link is established the upgrade facility as disclosed can identify any one of a plurality of end points that provide a better service rate than the currently associated end point, and can seamlessly switch the communications channel to the better service provider.

To the accomplishment of the foregoing and related ends, certain illustrative aspects of the disclosed and claimed subject matter are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a machine-implemented system that facilitates and effectuates resilient communications between clients comprising a cloud in accordance with the claimed subject matter.

FIG. 2A provides a more detailed block diagram of receiving component in accordance with one aspect of the claimed subject matter.

FIG. 2B is a more detailed depiction of a search component in accordance with another aspect of the subject matter as claimed.

FIG. 2C provides a detailed illustration of an authentication component in accordance with a further aspect of the claimed subject matter.

FIG. 2D depicts a machine implemented biometric component that can be included with an aspect of the subject matter as claimed.

FIG. 3 provides a detailed depiction of a connection component in accordance with the disclosed subject matter.

FIG. 4 illustrates a flow diagram of a methodology that facilitates and effectuates resilient communications between clients comprising a cloud in accordance with an aspect of the claimed subject matter

FIG. 5 provides a 3-dimensional depiction of a Q-dimensional search tree that can be utilized in accordance with an aspect of the disclosed subject matter.

FIG. 6 provides a graphic representation of a cloud with tagged content items.

FIG. 7 illustrates a block diagram of a computer operable to execute the disclosed inference-based query completion architecture.

FIG. 8 illustrates a schematic block diagram of an exemplary computing environment for processing the inference-based query completion architecture in accordance with another aspect.

### DETAILED DESCRIPTION

The subject matter as claimed is now described with reference to the drawings, wherein like reference numerals are used to refer to like elements throughout. In the following description, for purposes of explanation, numerous specific details are set forth in order to provide a thorough understanding thereof. It may be evident, however, that the claimed subject matter can be practiced without these specific details. In other instances, well-known structures and devices are shown in block diagram form in order to facilitate a description thereof.

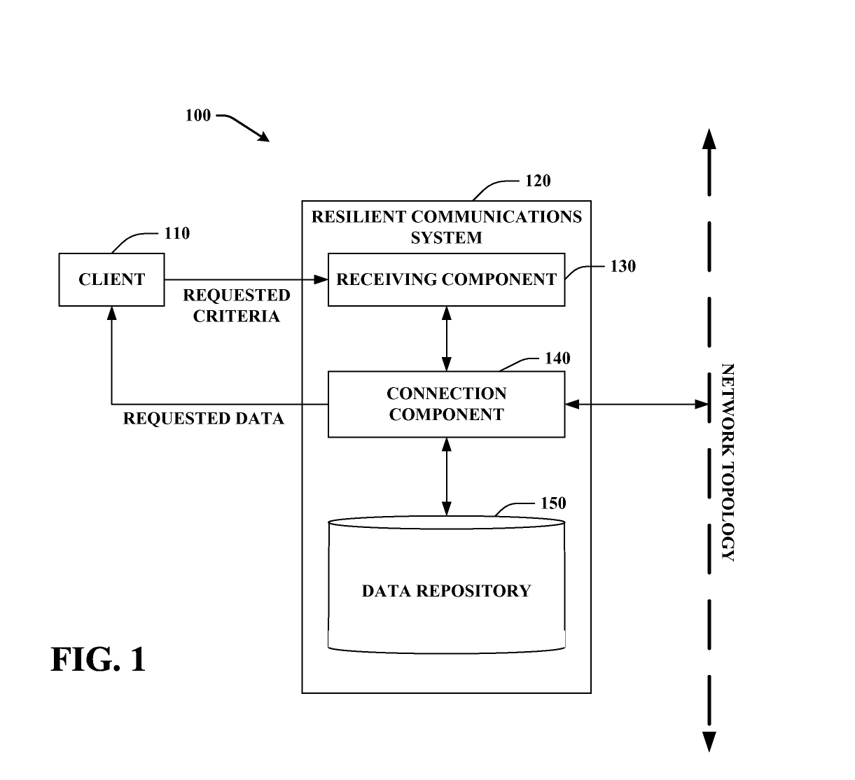

FIG. 1 illustrates a machine-implemented system 100 that facilitates and effectuates resilient communications between clients situated on a network topology that can comprise a “Cloud”. System 100 comprises a client 110 that generates and/or supplies a set of requested or desired criteria. Criteria supplied and/or generated by client 110 can emanate from both an application executing on client 110, or directly from a user entering criteria via a human interface device (not shown) associated with client 110. The criteria emanating from client 110 can include desired content (e.g., live/recorded video and/or audio content, academic papers/treatises, software licenses, digital certificates, photographs, vacation categories, legal statutes, legal opinions, and the like) that the application and/or user wishes to access, a putative endpoint (e.g., a web site, a service, . . . ) where the desired content might be available, and sets of desired communication parameters (e.g. minimal error rate, maximal bandwidth, frame size, etc.) under which the application and/or user wishes to receive the desired content.

System 100 further comprises a resilient communications system 120 that receives requested criteria from client 110 via receiving component 130. In one aspect, for example, receiving component 130 can receive a request from a client 110 for desired content, possible locations of the content, and one or more desired communication parameters. Receiving component 130 upon receipt of requested criteria from client 110 can utilize one or more techniques (e.g., boosting, data mining techniques, linear discriminant analysis, support vector machines, maximum entropy models, bootstrap aggregating, and the like) to ascertain the location of desired content. Further, receiving component 130 can request and receive authentication information that can be utilized by resilient communications system 120 to establish communications with the network topology and any and all clients that are extant on the network topology.

Resilient communications system 120 can also include a connection component 140 that determines whether to establish communications with one or more clients (end nodes) identified by receiving component 130 as possibly containing desired content, and once established conveys desired content to client 110. In other words, connection component 140 identifies one or more communication modalities that satisfy or nearly satisfy one or more desired communication requirements received by receiving component 130, and establishes communications with the communications modalities associated with desired content. In addition, connection component 140 can discriminate between several forms of desired content (e.g., emails, streaming audio/video presentations, documents that remain relatively static, etc.) prior to establishing communications with the one or more clients (end nodes) identified by receiving component 130. For example, connection component 140 can make a determination with respect to whether desired content relates to live streaming video, academic papers, software licenses, email, instant message date and the like, and can establish communications with the one or more clients based at least in part on such a determination. Thus, connection component 140, upon ascertaining that desired content in all likelihood pertains to low priority content (for instance, electronic mail or academic papers) can for example adaptively and automatically establish and maintain communications with the one or more clients within the lower bounds of the one or more desired communications parameters (e.g., a slower less reliable connection). Conversely, where connection component 140 determines that the desired content relates to high priority content, or content that requires the establishment of more reliable and consistent communications, connection component 140 can adaptively and automatically establish and maintain communications within the upper range of the one or more desired communications parameters (e.g. establish a fast extremely stable connection).

Connection component 140 further ensures that once communications have been established with a particular client that communications are maintained without interruption, and if there is interruption connection component 140 can automatically and seamlessly switch to an alternate end node that contains desired content. Additionally, connection component 140 can also provide an updating facility that during the course of communications between client 110 and the end node identified as containing desired data ascertains whether there are alternative end nodes capable of furnishing desired content to client 110 in a more expeditious manner, or that more closely correlate with the desired capabilities that the client 110 may have specified.

Moreover, resilient communications system 120 can also include a data repository 150 accessible by both receiving component 130 and connection component 150. Data repository 150 can contain, for example, one or more connection modality flowcharts, pre-established capabilities, and the like. Moreover data repository 150 can be designed under and/or subscribe to one or more of the following database modeling concepts: flat (table), hierarchical, network, relational, object-oriented, and dimensional models. Furthermore, data repository 150 can be employed to cache data in order to ensure seamless and continuous network connectivity from the perspective of users of system 100. Such seamless and continuous network connectivity can allow users to continue working on their respective tasks should a network failure occur or where intermittent connectivity is encountered. Additionally, data repository 150 can also be utilized where a user temporarily goes off-line for some reason to store incoming data for future use by the user. Further, such persisted information/data can allow for automatic data synchronization once connectivity has been re-established.

It should be noted with respect to the automatic data synchronization aspect set forth herein, that such a facility can be bi-directional; automatically propagating non-conflicting changes from data resident in the network topology to the client, and similarly dynamically disseminating non-conflicting changes in data emanating or originating from the client to the network topology (e.g. one or more clients that comprise the network topology). Additionally, it should also be noted that the claimed subject matter, where there are conflicting changes to data, either originating from the network topology or the client, can utilize conflict resolution policies (e.g., request input from users, employ artificial intelligence techniques, presumptively favor data emanating from the network topology, assumptively favor data resident locally, etc.) to resolve the conflict.

In an additional aspect of the claimed subject matter the data synchronization facility can ensure that data is propagated/disseminated over the network topology, or portions thereof, to provide many levels or degrees of redundancy and mirroring depending on the relative utility and quality ascribed to the data. Accordingly, the data synchronization aspect set forth herein can replicate data over multiple clients to increase data integrity, fault tolerance (e.g., enable continued operation in the event of failure of one or more of the clients persisting disseminated data) and data throughput, for example.

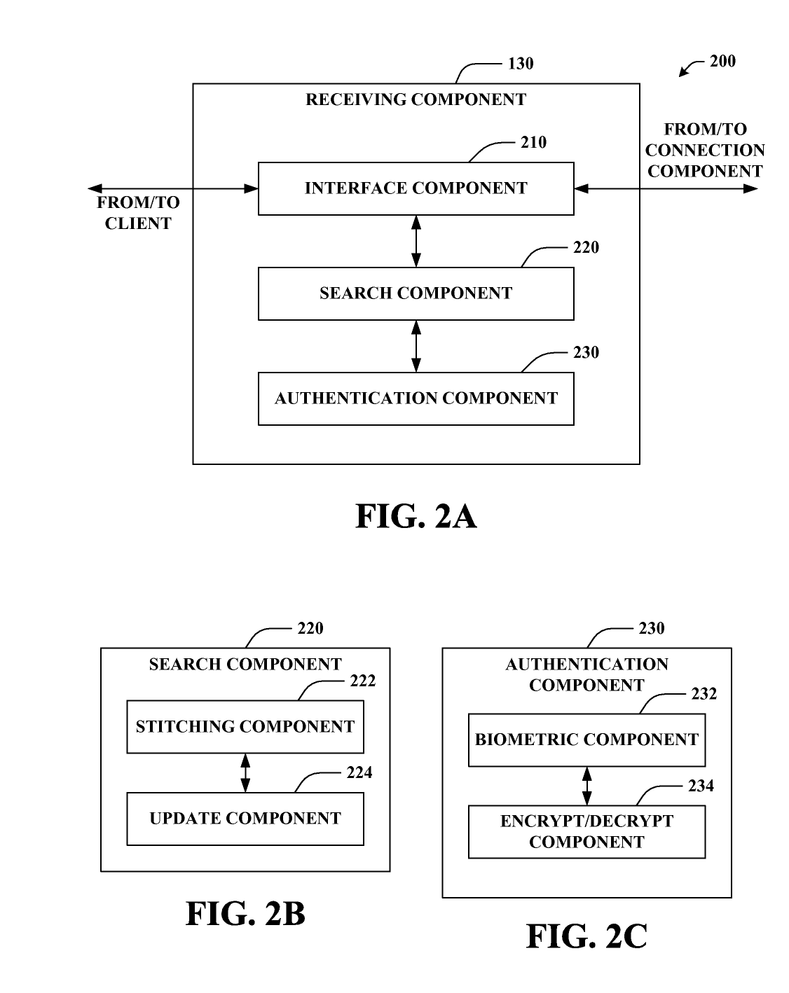

FIG. 2A provides a more detailed depiction of receiving component 130. Receiving component 130 can include an interface component 210 that can be in communications with connection component 140 and client 110 (See FIG. 1). Interface component 210 can receive desired criteria communicated by client 110, wherein such criteria pertains to desired content, prospective endpoints where the client perceives that desired content might reside, and one or more sets of desired communication parameters under which the client wishes to operate. Interface component 210 can further be in constant communication with connection component 140, wherein connection component 140 continuously streams or supplies data that is traversing the network topology at any instant in time for subsequent use by receiving component 130.

Receiving component 130 can also include a search component 220 that can employ one or more techniques such as boosting, linear discriminant analysis, bootstrap aggregation, etc., to determine location of the desired content. Additionally, receiving component 130 can further include an authentication component 230 that can request and receive authentication information utilized by the resilient communications system 120 in establishing communications with one or more endpoints identified by search component 220, as well as to provide necessary authentication information that may be needed to obtain, for example, software licenses, digital certificates, and the like. Moreover, in one aspect the authentication component 230 can dynamically effectuate security levels associated with particular communication channels established with the one or more endpoints to be adapted and/or adjusted based at least in part on a perceived relative priority of the data being interchanged, for example.

FIG. 2B provides a more detailed illustration of the search component 220 in accordance with an aspect of the claimed subject matter. The search component 220 can include a stitching component 222 that dynamically and contemporaneously locates pertinent information related to desired content received from a client 110 via interface component 210. At this juncture it should be noted that pertinent information/data related to desired content, or pertinent portions thereof, can be stored, distributed, and arbitrarily duplicated on clients throughout the network topology, and in some instances duplicate information/data can be extant on clients in the network topology. Thus, if certain segments of the network topology cease to be operational, the desired content can be located in different network segments without interruption to the flow of data to the user. The stitching component 222 can investigate the network topology via connection component 140 searching for one of a multiplicity of related items that correspond or closely correlate to the context of the desired content. The stitching component 222 can, when investigating the network topology to locate items of interest and correspondence with the desired content, utilize one of the many techniques currently extant in data mining, data clustering, and/or information retrieval, such as for example, entropy maximization, density boosting, expectation maximization, and the like. The stitching component 222 can thereby stitch or build a chain of related topics until such time that one or more identity between the desired content and one of the multiplicities of related items has been established. In this manner stitching component 222 can locate desired content. Alternatively and/or additionally, stitching component 222 can utilize one or more data bases that can reside in data repository 150 (See FIG. 1) or that are resident on the network topology, and/or can employ one or more data structures (e.g., hashes, heaps, Q-dimensional search trees, lists, associative arrays, B-trees, . . . ) or data models that can be previously and/or contemporaneously generated via update component 224 in order to determine an appropriate location from which desired content is accessible.

Additionally, search component 220 can include an update component 224 that assiduously and continuously monitors data supplied by the connection component 140. Data supplied by the connection component 140 can be provided as a continuous stream or as discrete packets of data. Update component 224 can upon receipt of supplied data can build and/or generate a data model or data structure representative and reflective of the current reality extant in the network topology.

FIG. 2C illustrates a more detailed depiction of an authentication component 230 that can be employed by the receiving component 130. Authentication component 230 can include a biometric component 232 that can request and receive biometric data from a user utilizing client 110 (See FIG. 1), and an encrypt/decrypt component 234 that can utilize information obtained from biometric component 232, as well as other information provided by other sources, such as for example, data repository 150 (See FIG. 1) or a password entered by a user of client 110, to ensure that communications established between client 110 and one or more endpoints on the network topology are secure. The encrypt/decrypt component 234 can employ, for example, public-key (asymmetric key), private key (symmetric key), and/or opportunistic encryption, to ensure that communications between client 110 and one or more endpoints identified by receiving component 130 are not compromised.

It should be noted authentication component 230 can correlate authentication and effectuates authentication hopping and/or passing between communication modalities and/or endpoints. For example, when individuals log onto and/or are authenticated to their devices (e.g., desktop computer, PDA, laptop, note book computer, Smartphone, cell phone, etc.) the corpus of authentication information obtained from this initial authentication can be dynamically propagated to other communication modalities and/or endpoints such that individuals, through the herein disclosed subject matter, can seamlessly and dynamically be connected to each and every communications endpoint that the claimed subject matter accesses. Such a facility permits access to any endpoints that the claimed subject matter might need access without the need for individuals to repeatedly and needlessly supply authentication information.

FIG. 2D provides a more detailed illustration of a biometric component 232 as utilized in one aspect of the claimed subject matter. Biometric component 232 includes a scanning module 240 that can be employed in conjunction with a scanner associated with client 110 and/or resilient communications system 120 to gather physical information related to a user. Information that can be obtained and utilized by biometric component 232 and more particularly by scanning module 240 includes data relating to, for example, retinal and/or iris scans, thumb prints, finger prints, handprints, footprints, vein scans, and the like.

Further, biometric component 232 can also include a voice recognition module 242 that can receive audio input from, for example, one or more microphones associated with client 110 and/or resilient communications system 120. Such audio input can be utilized by voice recognition module 242 in conjunction with one or more previously recorded voice files stored for example in data repository 150, to verify the authenticity of the individual utilizing client 110.

Moreover, biometric component 232 can also include a biometric card reader module 244 that can in concert with a biometric card reader affiliated with client 110 and/or resilient communications system 120 retrieve biometric data embedded within a biometric card presented to the biometric card reader. Typically biometric cards embed, on tiny chips (e.g., Radio Frequency Identification (RFID) chip) encapsulated on a card (e.g., paper, plastic, etc.) biometric information pertaining to an individual's particular physical characteristics such as, for example, hand and/or finger geometry, dermatoglyphics, facial characteristics, retinal and/or iris characteristics, and the like.

Additionally, biometric component 232 can include a gait recognition module 246 that can, in conjunction with one or more video camera associated with the client 110 and/or the resilient communications system 120, be employed to gather gait peculiarities associated with an individual's locomotion. Such gait peculiarities can subsequently be analyzed by gait recognition module 246 to verify the identity of a particular individual utilizing client 110. Furthermore, biometric component 232 can include writing analysis module 248 that, in conjunction with a tablet associated with client 110 and/or resilient communications system 120, can determine and authenticate an individual based on a handwriting exemplar, e.g., a persons handwritten signature.

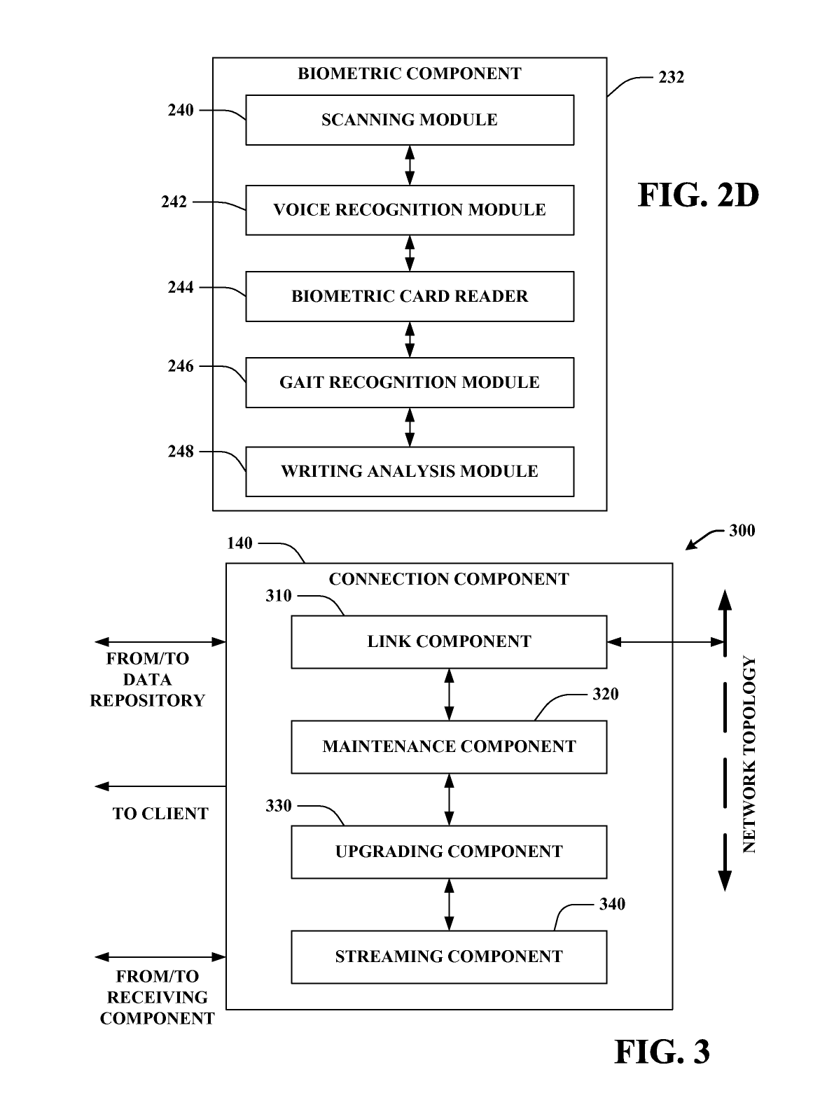

FIG. 3 provides a detailed illustration 300 of a connection component 140 in conformance with one aspect of the claimed subject matter. The connection component 140 can include a link component 310 that can retrieve one or more flow modality from the data repository 150 as well as accept from receiving component 130 an identified and/or indicated location or endpoint from where sought after content can be found. Link component 310 further can receive, by way of receiving component 130, a set of desired connection parameters (e.g., frame size, minimal error rate, maximal bandwidth, etc.) as well as encryption information generated by the encrypt/decrypt component 234 and utilized to establish secure communications with identified endpoints. Link component 310 upon receipt of such information can, based at least in part on desired connection parameters specified and/or a retrieved flow modality, determine whether a communications link can be established with a specified end node situated on the network topology. Where a communications link with an end node is currently unattainable (e.g. due to the node being inaccessible, none of the desired parameters being attainable, and the like) link component 310 can inform the client accordingly. Where a communications link with an end node is possible with a set of previously established optimal communications parameters, link component 310 can establish communications with the end point using these optimal but less than desired parameters and thereafter can transfer/receive data between client 110 and the end point. Where link component 310 deems that all the desired communication parameters can be attained link component 310 can automatically establish a communications link with the end node and transfers data to/from client 110.

Further, connection component 140 can also include a maintenance component 320 that vigilantly monitors the communications link established by link component 310. Maintenance component 320 constantly investigates/analyzes the established communications link between client 110 and the end node to ensure that the communications link once established does not fail or become degraded. Should maintenance component 320 discover that the communications link between client 110 and end point has failed or has become degraded (e.g., is no longer operating at least at the level of previously established optimal communications) maintenance component 320 can inform receiving component 130 of the failure, at which point receiving component 130 can supply alternate endpoints that can be utilized by link component 310 to establish communications with at least one alternate end point.

It should be noted at this point that when a communication failure or interruption occurs severing an established communications link between client 110 and end point, the subject matter as claimed is capable of re-establishing communications at the point of failure. For example, if it is assumed that client 110 is in the process of downloading a large video file from an end point via an established communication link, and then the maintenance component 320 determines that the link between client 110 and identified end point has become, or is becoming, moribund, the large video file does not need to be downloaded ab initio from an alternate end point, but rather from the point of failure. This is the case regardless of whichever end node that communications are subsequently re-established with.

Additionally and/or alternatively, maintenance component 320, based at least in part on detected degradation of the communications link between client 110 and end point, can dynamically direct receiving component 130 to locate and/or supply one or more endpoints that comport with a degree of degradation detected. Thus, maintenance component 320, for example, can automatically request that the quality of content be depreciated based on the perceived degree of degradation. For instance, an individual wishing to initiate an all-day long virtual meeting can initially activate a low-resolution videoconference meeting with his/her colleagues over a DSL level bandwidth connection from his/her home. Subsequently, the individual, while still attending the previously initiated videoconference meeting, may enter his automobile in order to travel to work, accordingly the established videoconference session can automatically be transferred to, and may need to dynamically conform to one or more mobile telephony standards. The maintenance component 320 recognizing that the previously established communications path between the client 110 and end point has to a certain degree been compromised can indicate to receiving component 130 that the content currently being delivered surpasses the capabilities of the degraded communications link and that alternate less contextually dense content needs to be supplied. In the context of the foregoing illustration, this can mean for example, dynamically locating and switching from delivering audio/visual content to merely providing a audio content, or alternatively appropriately reducing the resolution of the video. Similarly, maintenance component 320 can also provide a complimentary functionality when an improvement in a communications channel is detected. Thus, for example, where the individual, in keeping with the foregoing illustration, arrives at his/her office the videoconference session can once again be automatically transferred to a different communications medium. The maintenance component 320, upon recognizing that the communications channel between the client 110 and endpoint has improved, can apprise the receiving component 130 that the currently supplied content falls below the capabilities of the established communications channel, and that alternative contextually richer content needs to be located and supplied.

Moreover, connection component 140 can further include an upgrading component 330 that assiduously assays information supplied by receiving component 130 relating to prospective end points that can have better communication characteristics (e.g., characteristics that correlate closer to characteristics input and required by client 110). Upgrading component 330 when it detects that there are end points with better communication characteristics than are available with the currently connected end point and that have the same desired content can dynamically and seamlessly substitute the end point with better communication characteristics for the currently accessed end node. As stated above, such a substitution can be undertaken by the upgrading component 330 without the loss of continuity in the stream of data emanating from the currently accessed end node. In other words, when upgrading component 330 causes a substitution of end nodes, the substitution is imperceptible to client 110 so much so that from the client's 110 perspective communications have been carried out by one indistinguishable end point throughout the communications session.

Additionally, connection component 140 can include a streaming component 340 that continuously investigates the network topology to locate additions to the network topology. Additions to the network topology can include both additions and addendums to the topology, and typically can take the form of upgrades and/or diminution in communication characteristics by end points, change of content in relation to an end point, and the like. Whenever streaming component 340 determines that there has been a change, no matter how imperceptible, streaming component 340 can convey these changes to receiving component 130 for further analysis.

As will be appreciated, various portions of the disclosed systems above and methods below may include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the search component 220, authentication component 230, stitching component 222 and connection component 140 can as warranted employ such methods and mechanisms to infer context from incomplete information, and learn and employ user preferences from historical interaction information.

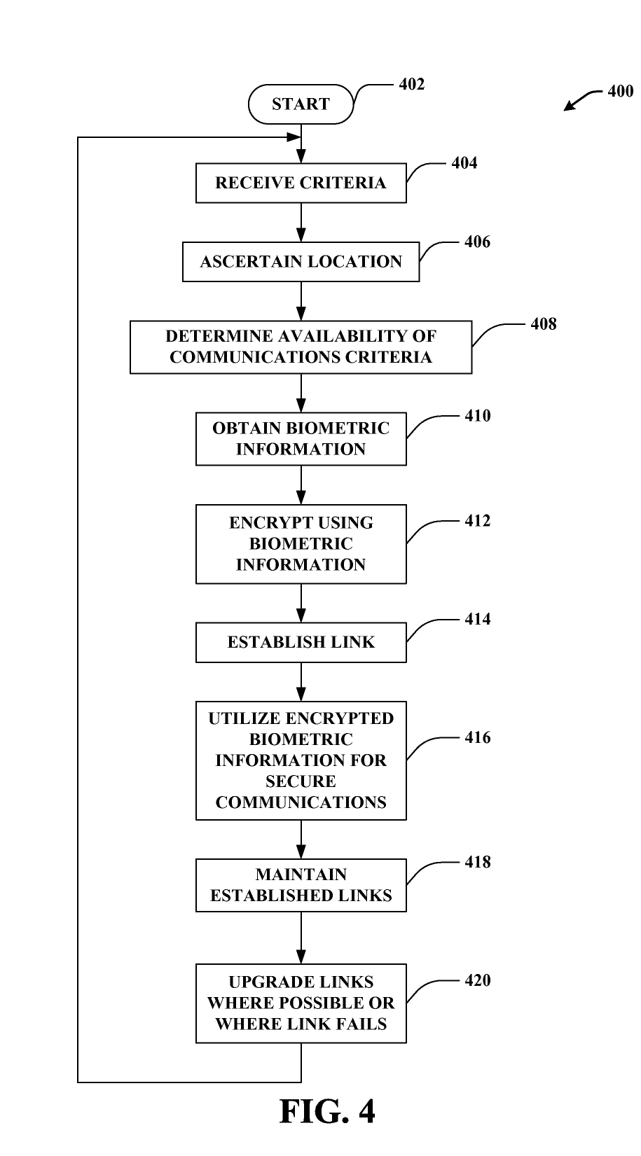

In view of the exemplary systems described supra, methodologies that may be implemented in accordance with the disclosed subject matter will be better appreciated with reference to the flow chart of FIG. 4. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers.

FIG. 4 illustrates a methodology 400 that facilitates and effectuates resilient communications between clients comprising a cloud in accordance with an aspect of the claimed subject matter. At 402 the modality commences by undertaking various processor initialization tasks and background activities that can be performed as power is applied to the resilient communications system. After these tasks have been performed the method proceeds to 404. At 404 a set of desired criteria are received, the criteria can, for example, relate to desiderate content (e.g. academic treatises, digital certificates, photographs, audio/visual content, . . . ), a request for interaction with suggested/putative end points (e.g., website, web service, and the like), and aspirational communication criteria (e.g., error rate, bandwidth, frame size, etc.). Having solicited relevant criteria at 404, the methodology proceeds to 406 where solicited desiderate content criteria is utilized in conjunction with one or more techniques (e.g., density boosting, bootstrap aggregating, data mining techniques, and the like) to ascertain a putative/possible location (e.g., probable end node(s)) of desired content. At 408 the method utilizes previously supplied aspirational communication criteria to determine whether any of the suggested locations identified at 406 have the ability to establish communications in conformance with the aspirational communication criteria. Where at 408 it is determined that communications in conformance with all the aspiration communication criteria is currently unattainable, the modality can inform a user or client accordingly. Where at 408 it is determined in conjunction, and/or in consultation, with information from, for example, a data repository, that communications with a suggested end point or location can be established with a set of previously utilized optimal communication characteristics, indication of this can be made for subsequent use by the methodology. Where at 408 it is ascertained that all the desired parameters requested can be attained, then note of this fact can be made for subsequent use. The methodology then proceeds to 410 where biometric information can be obtained. In addition to biometric information other authentication information can be acquired at this stage. Other authentication information can include retrieving username and password data from a user. At 412, and if indication is provided at 408 that communications in conformance with some or all the aspirational communication criteria can be established, the method generates an encryption key utilizing biometric and other authentication information acquired at 410. At 414 a communications link between the client and identified end point is established, and at 416 the encryption key generated at 412 is employed to ensure that communications between the client and the selected end point are secure. Once a communications link has been established at 414 a maintenance and an upgrade functionality is initiated at 418 and 420 respectively, wherein at 418 a process assiduously monitors the established communications link to detect failures or deterioration in the communications link. If a failure is detected, or if it is perceived that there has been deterioration in the communications link, the maintenance process can initiate remedial measure to rectify the situation. Similarly, at 420 with respect to the upgrade functionality, once initiated the upgrade process constantly monitors incoming data from the network topology to identify end nodes that can have better extant communication characteristics. Where such an occurrence manifests itself at 420, the upgrade process can automatically and seamlessly substitute or switch end points to the one with better service characteristics.

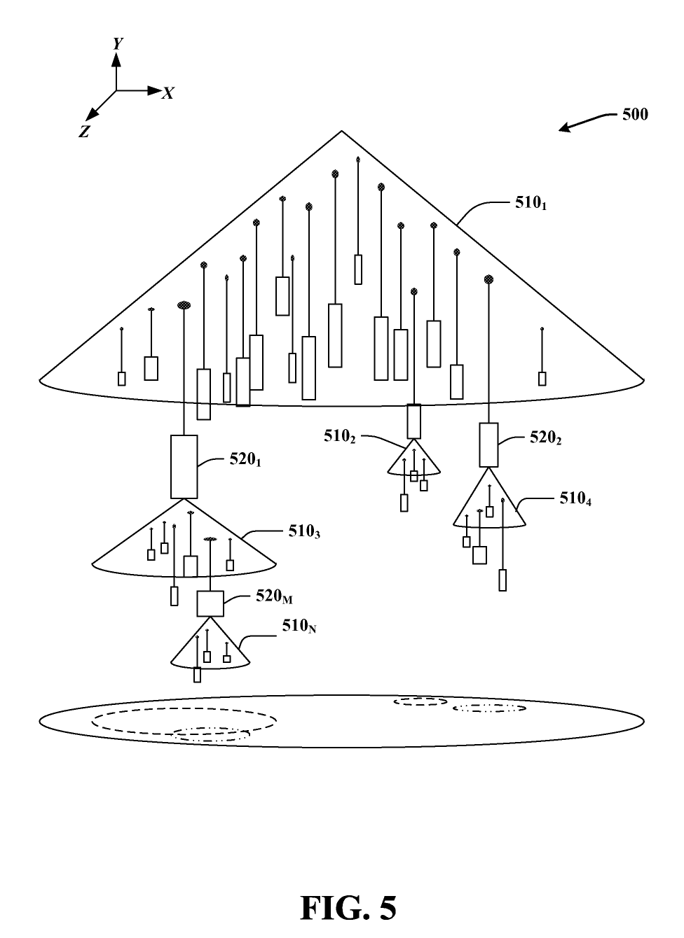

FIG. 5 is a 3-dimensional depiction 500 of a Q-dimensional search tree structure wherein Q is an integer greater than zero. Such a Q-dimensional search tree can be represented as a series of conical surfaces (510₁, 510₂, 510₃, 510₄, . . . 510_{N}, N being a natural number greater than zero) from which depend a plethora of leaves (520₁, 520₂, . . . 520_{M}, where M is an integer greater than zero). Such a Q-dimensional traversal data structure can facilitate expeditious identification of content that can be dispersed over the vastness of the cloud.

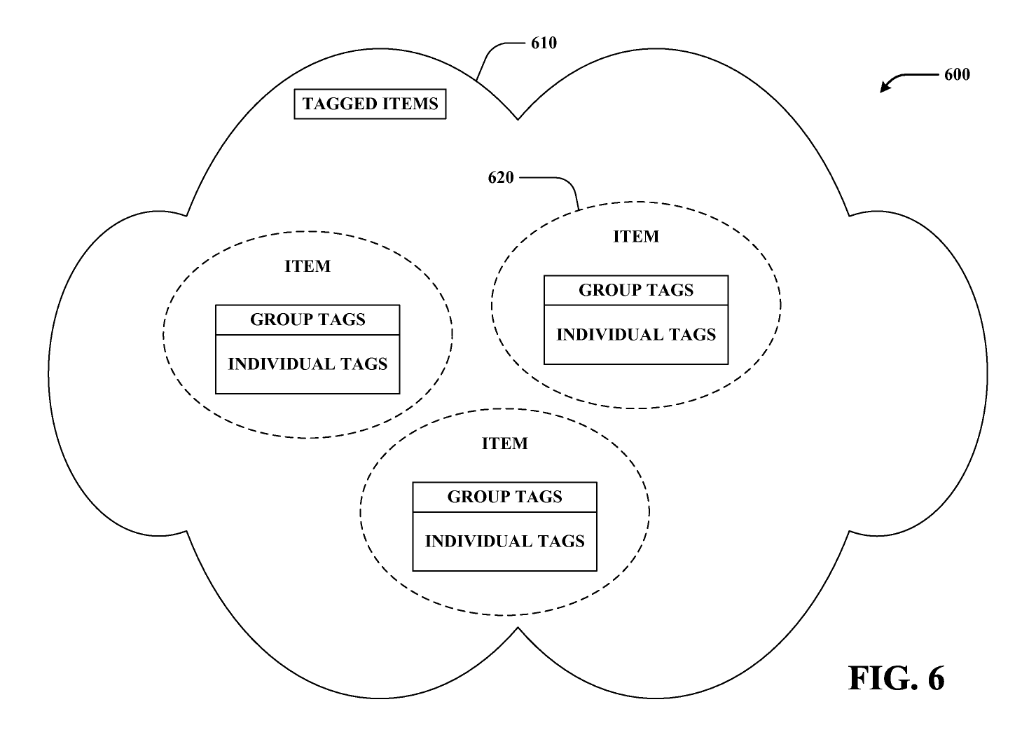

FIG. 6 provides a graphic representation 600 of a cloud wherein items (i.e., content, or data objects) extant in the cloud, such as text files, music files, software licenses, digital certificates, and the like, can be placed on an end point (e.g. a computing device) and exposed to access by individuals claiming membership to the cloud or network topology. Such content placed in or made accessible to the cloud, in order to facilitate rapid identification and possible utilization of the content, can be tagged based on user preferences, wherein tags associated with each item can be employed to organize and identify relevant websites, articles, and other items related to the content at issue. Thus, such tagged items enable users to classify content, both for individual use and for collective use (e.g., by other applications and clients).

In accordance with one aspect of the claimed subject matter the resilient communications system disclosed herein can therefore employ the tags associated with content to identify desired content specified by a client as well as to build a traversal tree (e.g., a Q-dimensional search tree) that can provide an index for future taxonomy applications. As illustrated in FIG. 6, cloud 610 contains a multiplicity of items 620. Each item 620 can include a set of group tags and individual tags, wherein individual and group tags are specified by individual users to aid in better classifying content contained within item 620. Such tags (group and individual) can be utilized to expeditiously locate desired content specified by a client or application. In this manner the resilient communications system can locate multiple instances of content that can be used to provide the content to the client or application.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

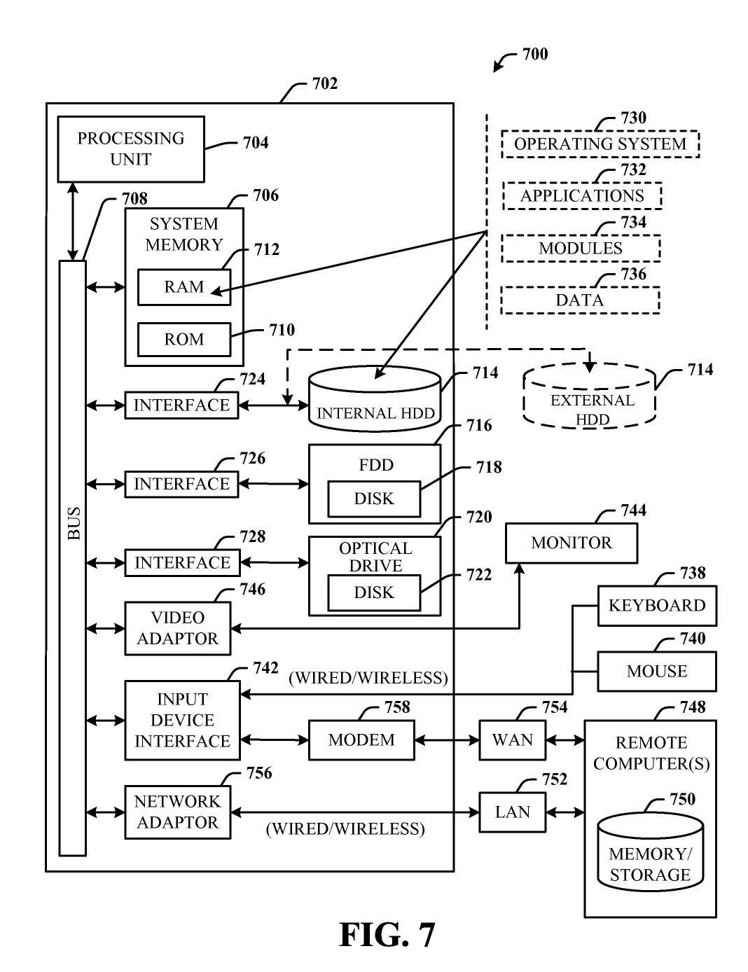

Referring now to FIG. 7, there is illustrated a block diagram of a computer operable to execute the disclosed resilient communications system. In order to provide additional context for various aspects thereof, FIG. 7 and the following discussion are intended to provide a brief, general description of a suitable computing environment 700 in which the various aspects of the claimed subject matter can be implemented. While the description above is in the general context of computer-executable instructions that may run on one or more computers, those skilled in the art will recognize that the subject matter as claimed also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 7, the exemplary environment 700 for implementing various aspects includes a computer 702, the computer 702 including a processing unit 704, a system memory 706 and a system bus 708. The system bus 708 couples system components including, but not limited to, the system memory 706 to the processing unit 704. The processing unit 704 can be any of various commercially available processors. Dual microprocessors and other multi-processor architectures may also be employed as the processing unit 704.

The system bus 708 can be any of several types of bus structure that may further interconnect to a memory bus (with or without a memory controller), a peripheral bus, and a local bus using any of a variety of commercially available bus architectures. The system memory 706 includes read-only memory (ROM) 710 and random access memory (RAM) 712. A basic input/output system (BIOS) is stored in a non-volatile memory 710 such as ROM, EPROM, EEPROM, which BIOS contains the basic routines that help to transfer information between elements within the computer 702, such as during start-up. The RAM 712 can also include a high-speed RAM such as static RAM for caching data.

The computer 702 further includes an internal hard disk drive (HDD) 714 (e.g. EIDE, SATA), which internal hard disk drive 714 may also be configured for external use in a suitable chassis (not shown), a magnetic floppy disk drive (FDD) 716, (e.g., to read from or write to a removable diskette 718) and an optical disk drive 720, (e.g., reading a CD-ROM disk 722 or, to read from or write to other high capacity optical media such as the DVD). The hard disk drive 714, magnetic disk drive 716 and optical disk drive 720 can be connected to the system bus 708 by a hard disk drive interface 724, a magnetic disk drive interface 726 and an optical drive interface 728, respectively. The interface 724 for external drive implementations includes at least one or both of Universal Serial Bus (USB) and IEEE 1394 interface technologies. Other external drive connection technologies are within contemplation of the claimed subject matter.

The drives and their associated computer-readable media provide nonvolatile storage of data, data structures, computer-executable instructions, and so forth. For the computer 702, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed and claimed subject matter.

A number of program modules can be stored in the drives and RAM 712, including an operating system 730, one or more application programs 732, other program modules 734 and program data 736. All or portions of the operating system, applications, modules, and/or data can also be cached in the RAM 712. It is to be appreciated that the claimed subject matter can be implemented with various commercially available operating systems or combinations of operating systems.

A user can enter commands and information into the computer 702 through one or more wired/wireless input devices, e.g. a keyboard 73 8 and a pointing device, such as a mouse 740. Other input devices (not shown) may include a microphone, an IR remote control, a joystick, a game pad, a stylus pen, touch screen, or the like. These and other input devices are often connected to the processing unit 704 through an input device interface 742 that is coupled to the system bus 708, but can be connected by other interfaces, such as a parallel port, an IEEE 1394 serial port, a game port, a USB port, an IR interface, etc.

A monitor 744 or other type of display device is also connected to the system bus 708 via an interface, such as a video adapter 746. In addition to the monitor 744, a computer typically includes other peripheral output devices (not shown), such as speakers, printers, etc.

The computer 2202 may operate in a networked environment using logical connections via wired and/or wireless communications to one or more remote computers, such as a remote computer(s) 748. The remote computer(s) 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wired/wireless connectivity to a local area network (LAN) 752 and/or larger networks, e.g., a wide area network (WAN) 754. Such LAN and WAN networking environments are commonplace in offices and companies, and facilitate enterprise-wide computer networks, such as intranets, all of which may connect to a global communications network, e.g., the Internet.

When used in a LAN networking environment, the computer 702 is connected to the local network 752 through a wired and/or wireless communication network interface or adapter 756. The adaptor 756 may facilitate wired or wireless communication to the LAN 752, which may also include a wireless access point disposed thereon for communicating with the wireless adaptor 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wired or wireless device, is connected to the system bus 708 via the serial port interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+ Mbps in the 2.4 GHz band. Products can contain more than one band (e.g., dual band), so the networks can provide real-world performance similar to the basic 10BaseT wired Ethernet networks used in many offices.

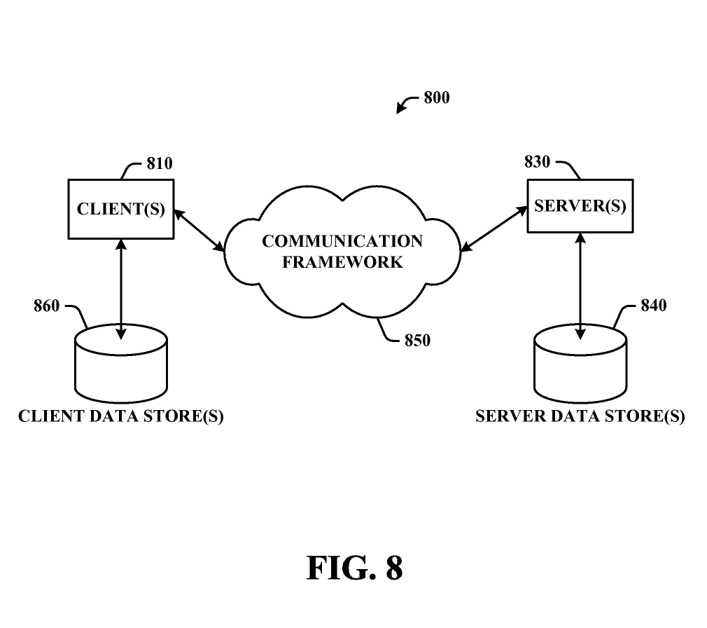

Referring now to FIG. 8, there is illustrated a schematic block diagram of an exemplary computing environment 800 for processing the inference-based query completion architecture in accordance with another aspect. The system 800 includes one or more client(s) 802. The client(s) 802 can be hardware and/or software (e.g., threads, processes, computing devices). The client(s) 802 can house cookie(s) and/or associated contextual information by employing the claimed subject matter, for example.

The system 800 also includes one or more server(s) 804. The server(s) 804 can also be hardware and/or software (e.g., threads, processes, computing devices). The servers 804 can house threads to perform transformations by employing the invention, for example. One possible communication between a client 802 and a server 804 can be in the form of a data packet adapted to be transmitted between two or more computer processes. The data packet may include a cookie and/or associated contextual information, for example. The system 800 includes a communication framework 806 (e.g., a global communication network such as the Internet) that can be employed to facilitate communications between the client(s) 802 and the server(s) 804.

Communications can be facilitated via a wired (including optical fiber) and/or wireless technology. The client(s) 802 are operatively connected to one or more client data store(s) 808 that can be employed to store information local to the client(s) 802 (e.g., cookie(s) and/or associated contextual information). Similarly, the server(s) 804 are operatively connected to one or more server data store(s) 810 that can be employed to store information local to the servers 804.

What has been described above includes examples of the disclosed and claimed subject matter. It is, of course, not possible to describe every conceivable combination of components and/or methodologies, but one of ordinary skill in the art may recognize that many further combinations and permutations are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system implemented on a machine that retrieves desired data from disparate clients resident on a network topology, comprising:
a reception component that obtains a request for desired data; and
a connection component that locates the desired data resident on an identified client and establishes communications with the identified client based at least in part on a data type associated with the desired data.

2. The system of claim 1, the connection component receives one or more preferred communication parameters from the reception component.

3. The system of claim 2, the connection component based at least in part on the one or more preferred communication parameters and the data type associated with the desired data establishes communications with the identified client at an upper range of the one or more preferred communication parameters.

4. The system of claim 2, the connection component based at least in part on the one or more preferred communication parameters and the data type associated with the desired data adaptively maintains communications with the identified client at an upper range of the one or more preferred communication parameters.

5. The system of claim 2, the connection component based on the one or more preferred communication parameters and a change in the data type associated with the desired data dynamically adapts communications with the identified client to one of an upper range or a lower range of the one or more preferred communication parameters.

6. The system of claim 1, the desired data includes one or more of electronic mail, software licenses, digital certificates, streaming data, or static data.

7. The system of claim 1, further including an authentication component that dynamically adjusts a security level associated with the communications based at least in part on a perceived relative priority associated with the desired data.

8. The system of claim 7, the authentication component retrieves biometric information from an associated biometric component, the biometric information employed to assert one of a greater or lesser degree of security to the communications with the identified client.

9. The system of claim 7, the authentication component generates an encryption key to ensure secure communication with the identified client.

10. The system of claim 1, the connection component retrieves an establishment logic algorithm from a data repository.

11. The system of claim 1, the connection component dynamically and seamlessly transfers communications to a second identified client where communications with the identified client ceases to function.

12. A machine implemented method that effectuates retrieval of desired data from disparate clients that form a network topology, comprising:
obtaining a request for desired data from an application;
identifying a client that has persisted the desired data; and
establishing an adaptively modifiable communication link with the client based on a data attribute associated with the desired data.

13. The method of claim 12, further including retrieving desired communication parameters, the desired communication parameters include at least one of desired frame size, bit rate, and error rate.

14. The method of claim 13, the desired communication parameters and the data attribute associated with the desired data employed to establish the adaptively modifiable communication link with the client at a lower range of the desired communications parameters

15. The method of claim 13, the desired communication parameters and the data attribute associated with the desired data utilized to maintain the adaptively modifiable communication link with the client at a lower range of the desired communications parameters.

16. The method of claim 13, the desired communication parameters and the data attribute associated with the desired data employed to automatically one of upgrade or downgrade the adaptively modifiable communication link with the client to one of an upper range or a lower range of the desired communication parameters.

17. The method of claim 12, further including adjusting a security level associated with the adaptively modifiable communication link based on a priority associated with the desired data.

18. The method of claim 12, the desired data includes recorded audio/visual content, instant message data, static data, dynamic data, and digital certificates.

19. The method of claim 12, further including retrieving authentication information from one of a data repository or a biometric component and utilizing the authentication information to automatically adjust a security parameter associated with the adaptively modifiable communication link

20. A system that obtains desired content from disparate endpoint arranged to form a cloud, comprising:
means for locating the desired content on one endpoint included in the cloud;
means for establishing a connection with the one endpoint, the connection dynamically adaptable based on changes in the desired content during the connection with the one endpoint.
